(19) United States
(12) Patent Application Publication
(10) Pub. No.: US 2014/0115759 A1
(43) Pub. Date: May 1, 2014

(54) Electronic Device for Impact Sport Head Protectors

(71) Applicant: Helmet HALO Technologies, LLC, Norwalk, CT (US)

(72) Inventors: Jerome D. Tomlin, Norwalk, CT (US); Frank D. Sundermeyer, Prospect, CT (US)

(73) Assignee: Helmet HALO Technologies, LLC, Norwalk, CT (US)

(21) Appl. No.: 14/061,942

(22) Filed: Oct. 24, 2013

Related U.S. Application Data
(60) Provisional application No. 61/719,526, filed on Oct. 29, 2012.

(51) Int. Cl. A63B 71/10; G08B 21/02

(52) U.S. Cl. CPC A63B 71/10; G08B 21/02
USPC 2/411; 340/689; 2/410

(57) ABSTRACT

An electronic device is provided for use in an impact sport head protector. The device includes a tilt sensor that generates at least one output signal representing tilt orientation of the head protector. A processor is configured to sample and process the tilt sensor output signal(s) over a number of successive cycles to determine whether the head protector is in an unsafe position during a given cycle and to generate an alarm signal based on such determination at least for the given cycle. An audio device is configured to produce an audible alarm in response to such alarm signal. The processor is configured to remove the effect of noise components in the tilt sensor output signal(s) in generating the alarm signal. The processor can also be configured to constrain the time delay that the head protector is in an unsafe position before raising the alarm signal.

### CROSS-REFERENCE TO RELATED APPLICATIONS

The present application claims priority from U.S. Provisional Patent Application No. 61/719,526, filed on Oct. 29, 2012, herein incorporated by reference in its entirety.

### BACKGROUND

1. Field

The present application relates to head protectors for impact sports (such as football helmets, men's lacrosse helmets, ice hockey helmets and rugby head protectors). More particularly, the present application relates to electronic devices for impact sport head protectors.

2. Related Art

There are a number of sports in which participants experience hard collisions with other players. These sports are generally considered impact sports (or high-impact sports) and include, for example, football, men's lacrosse, ice hockey, and rugby. A participant of such impact sports may suffer severe neck or other related injuries as a result of having his head in an unsafe position during a collision. For example, the head of a participant may be tilted far forward relative to the body at the moment of impact. This is an unsafe head position that risks neck or other related injuries to the participant. Learning to maintain a safe head tilt angle at the moment of impact must be taught to young or inexperienced participants that would otherwise typically have the tendency to place their head in an unsafe position at impact.

For example, in the game of football (gridiron football), a player can deliver and receive forceful tackles and blocks. In such maneuvers, it is essential that the player keeps his head up and not down, or risk neck or other related injuries. Young and/or inexperienced participants must be taught to keep their head up with respect to their body during such maneuvers, as it is the natural tendency for inexperienced players to place their head down in an unsafe position at impact.

### SUMMARY

According to an aspect of the present application, an electronic device is provided for use in an impact sport head protector. The electronic device includes a tilt sensor that generates at least one output signal representing tilt orientation of the head protector. A processor is operably coupled to the tilt sensor. The processor is configured to sample and process the at least one output signal of the tilt sensor over a number of successive cycles, wherein the processing for a given cycle determines whether the head protector is positioned in an unsafe position during the given cycle and generates an alarm signal based on such determination at least for the given cycle. An audio device is operably coupled to the processor. The audio device is configured to produce an audible alarm in response to the alarm signal generated by the processor. The processing of the processor is configured to filter or remove the effect of unwanted noise components in the at least one output signal of the tilt sensor in generating the alarm signal. Such filter processing is also configured to constrain the time delay (t_{alarm-delay}) that the head protector is in an unsafe position before raising the alarm condition in order provide adequate warning of the unsafe helmet position to the user such that the user can correct his/her head position during use.

Such filter processing advantageously reduces false positive determinations of unsafe position and resultant false alarm signals.

In some embodiments, the processor is configured to maintain count data pertaining to the determination whether the head protector is positioned in an unsafe position during a number of cycles, and the processor generates an alarm signal based upon evaluation of the count data and predefined threshold criterion.

In some embodiments, the processor selectively controls the audio device to produce the audible alarm in response to the alarm signal generated by the processor. The processor can selectively control the audio device to produce the audible alarm for a predetermined duration in response to the alarm signal generated by the processor.

The processor can track a time period Ta over successive cycles that the alarm signal is generated, and the processor can selectively control the audio device to produce the audible alarm for a predetermined duration based upon the time period Ta. For example, the processor can control the audio device to produce the audible alarm for the predetermined duration in the event that the time period Ta is less than a predetermined threshold criterion. Such processing can control the audio device to produce a series of audible alarm tones (e.g., beeps) in the event that the head protector is maintained in an unsafe position over multiple cycles.

In some embodiments, the processor is configured such that, in the event that the processing for a given cycle determines that the head protector is not positioned in an unsafe position in the given cycle, the processor places itself into a low-power state for a predetermined period of time before the next cycle. In the low-power state, parts of the processor as well as the tilt sensor are deactivated for reduced power consumption.

In some embodiments, the processor tracks a time period Tp since the last change in the at least one output signal of the tilt sensor, and the processor selectively controls itself to enter a low-power state based upon the time period Tp. In the low-power state, parts of the processor as well as the tilt sensor are deactivated for reduced power consumption.

The device can further include a user-activated switch. The processor can be initially configured in a lower state and be configured to wake from the low-power state in response to user-activation of the switch. In the low-power state, parts of the processor as well as the tilt sensor are deactivated for reduced power consumption.

In some embodiments, the processing of the processor in a given cycle includes digital filtering that rejects unwanted noise components in the at least one output signal of the tilt sensor. The output of such digital filtering can be used to determine whether the head protector is positioned in an unsafe position during a given cycle and/or to generate the alarm signal.

In some embodiments, the device can include a housing that encloses the device, wherein the housing in configured to be supported by a part of the head protector. In one example, the housing is configured to fit into an opening of the head protector that is adjacent an ear of the user.

According to another aspect of the present application, a head protector for an impact sport includes an electronic device as described herein.

In some embodiments, the head protector includes a shock-absorbing structure and the electronic device is integral to a portion of the shock-absorbing structure. In one example, the portion of the shock-absorbing structure is a jaw pad.

In some embodiment, the head protector includes a protective outer shell and the electronic device is supported within a compartment integral to the protective outer shell.

In some embodiments, the electronic device can be supported within a compartment integral to a chin strap for a head protector.

### BRIEF DESCRIPTION OF THE DRAWINGS

FIG. 1 is a perspective view of a football helmet.

FIG. 2 is a front exploded partial view of a shock-absorbing liner that is part of the football helmet of FIG. 1.

FIG. 3 is a plan view of a right jaw pad that is part of the shock-absorbing liner of FIG. 2, which shows the electronic device of the present application integrated into a recess formed in an outer-facing surface of the right jaw pad.

FIG. 4A is schematic illustration depicting the operation of an optoelectronic tilt sensor.

FIG. 4B is a table that illustrates the digital output signals of the optoelectronic tilt sensor of FIG. 4A.

FIG. 5 is a schematic view of an exemplary embodiment of an electronic device according to the present application.

FIG. 6 is a flow chart of exemplary cyclical operations of the processor of the electronic device, where such operations activate the tilt sensor and sample and process the electrical signal(s) output by the tilt sensor for detection of unsafe helmet position.

FIG. 7 is a flow chart of exemplary operations that process the digital data representative of the tilt orientation of the tilt sensor for multiple cycles in order to determine whether or not to raise an alarm flag corresponding to an unsafe helmet position; such processing utilizes head-tilt discrimination filtering that filters out or removes the effect of such unwanted high frequency noise in the output signal(s) of the tilt sensor.

### DETAILED DESCRIPTION OF THE PREFERRED EMBODIMENTS

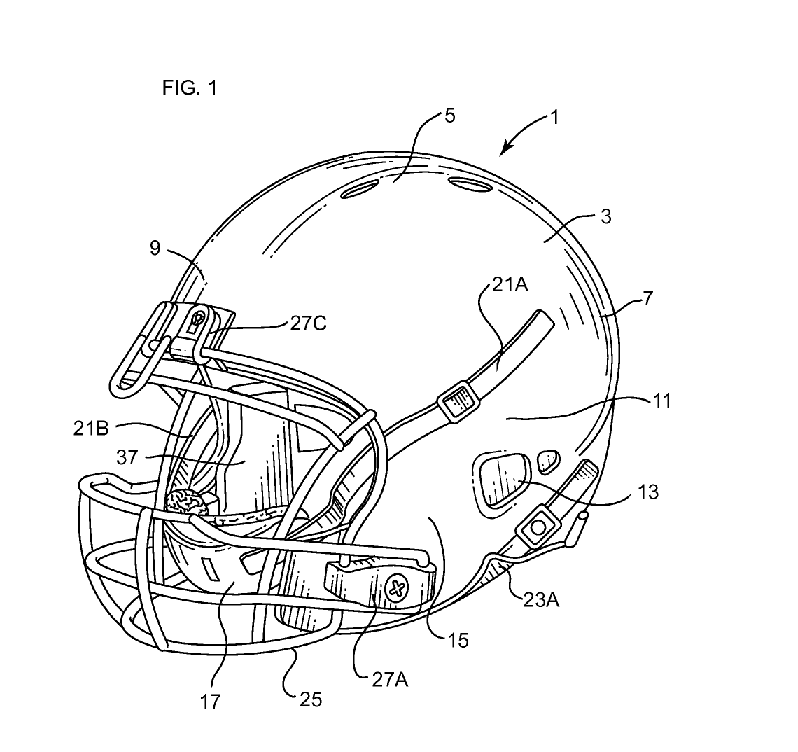

FIG. 1 is a schematic perspective view of a football helmet 1 that embodies the inventive features of the present application. The football helmet 1 includes a one-piece outer shell 3 made of a suitable plastic material having the requisite strength and durability characteristics to function as a football helmet. Examples of such plastic materials include polycarbonate materials such as LEXAN®. The outer shell 3 is adapted to receive the head of a user. The outer shell 3 includes a number of sections that cover different parts of the user's head. These sections include a crown section 5, a back section 7, a front section 9, a left side section 11 opposite a right side section (not shown). The left and right side sections include respective ear openings (one shown as 13) as well as jaw flaps (one shown as 15) that extend forward relative to the corresponding ear opening to cover the lower jaw of the user. The helmet 1 further includes a chin protector pad 17 that is supported by flexible straps that are secured to the outer surface of the outer shell 3. In the embodiment shown, the straps include a set of upper straps 21A, 21B that are connected to the outer surface of the upper part of the left and right side sections, respectively, of the outer shell 3. The straps also include a set of lower straps (one shown as 23A) that are connected to the outer surface of the lower part of the left and right side sections, respectively, of the outer shell 3. The connection of the flexible straps to the outer surface of the outer shell 3 is preferably provided by snap connectors as are well known in the art.

The football helmet 1 also includes a face guard 25 formed of a framework of wire members. The framework of wire members generally protects the face of the user while allowing for sight through the framework of wire members. The wire members can be formed of a suitable material having the requisite strength and durability characteristics to function as a football helmet face guard. Examples of such suitable materials include metals (such as steel) or plastic material. Metal wire members of the face guard 25 can have a solid or tubular construction, and can be coated with plastic. The face guard 25 is connected to the outer surface of the outer shell 3 by a set of opposed connectors (one shown as 27A) and clips (one shown as 27C) that are secured to the outer surface of the outer shell 3. The connectors (27A) mate to the opposed sides of the face guard 25 while being secured to the outer surface of the respective jaw flap of the outer shell 3 as shown. The connectors (27A) can act as shock absorbers that absorb impact forces exerted on the face guard 25. The clips (27C) mate to the top side of the face guard 25 while being secured the outer surface of the front section 9 of the outer shell 3 as shown.

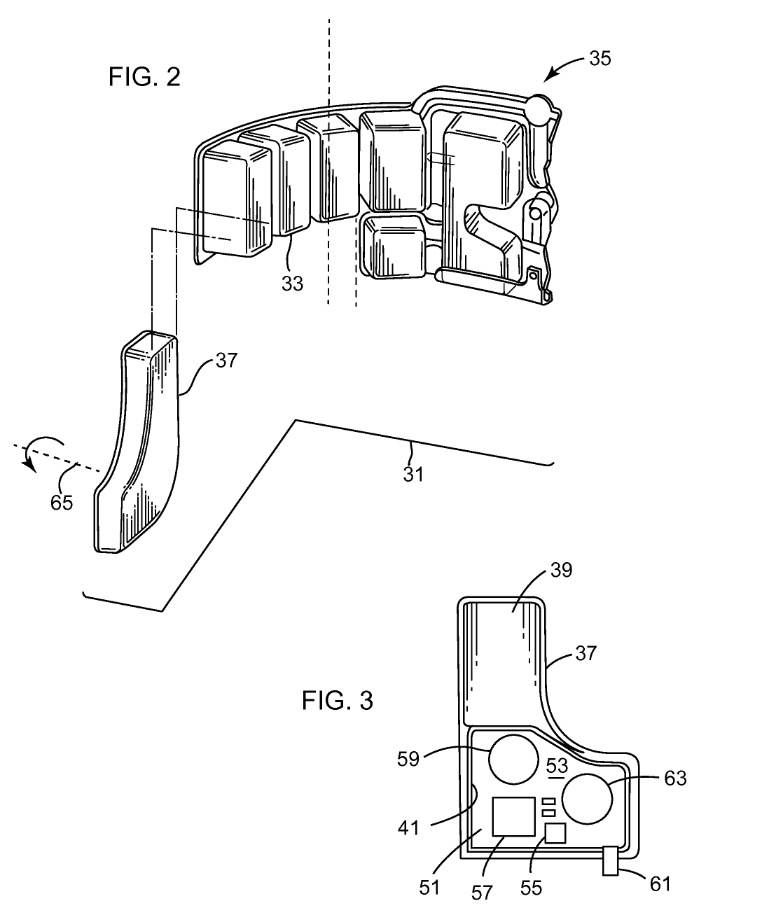

The football helmet 1 also includes a shock-absorbing liner 31 as best shown in FIG. 2. The liner 31 is connected to the inner surface of the outer shell 3, for example by a releasable loop and hook fastener means (which is generally referred to as a VELCRO® attachment). The liner 31 generally includes a number of resilient members 33 that are disposed along the inner surface of the left and right side sections and the back section of the outer shell 3. The members 33 of the liner 31 are adapted to absorb impact forces exerted upon the outer shell 3. The football helmet 1 can also include a shock absorbing pad (not shown) that is connected to the inner surface of the crown section 5 of the outer shell 3, for example by a releasable loop and hook fastener means. The shock absorbing pad generally includes one or more resilient members that are disposed along the inner surface of the crown section 5 of the outer shell 3. The one or more members of the crown pad are adapted to absorb impact forces exerted upon the outer shell 3. Examples of the construction of the liner 31 and crown pad are disclosed in U.S. Pat. No. 7,240,376, herein incorporated by reference in its entirety. A variety of different padding materials can be used for the resilient members of the liner 31 and the crown pad. For example, PVC nitrile foam, rubber foam or polyurethane foam can be used. Multiple layers of foam padding material can be used as well. The resilient members can also use pressurized fluid (such as air) and can be inflatable with one or more valves and orifices as is well known in the art.

As best shown in FIG. 2, the liner 31 includes a main section 35 as well as a right pad 37 and a left jaw pad (not shown). The right and left jaw pads are disposed along the inner surface of the corresponding right and left jaw flaps of the outer shell 3. Each jaw pad includes one or more resilient members that are positioned between the inner surface of the corresponding jaw flap of the outer shell 3 and the user's lower jaw for protection.

As best shown on FIG. 3, the surface 39 of the right jaw pad 37 that faces the right jaw flap of the outer shell 3 includes a recess 41 that is sized to receive and support an electronic device 51. The electronic device 51 includes a printed circuit board 53 that supports a tilt sensor 55, a processor 57 and supporting circuitry, a battery 59, a switch 61 and an audio speaker 63. A housing (not shown) can enclose the printed circuit board 53 and the components of the device 51 if desired. A cloth (or leather) jacket (not shown) can cover the right jaw pad 37. The jacket can provide for hook and loop fastener means or other suitable connector(s) (e.g., snap connector(s)) that connect the jaw pad to the inner surface of the right jaw flap of the outer shell 3. In this case, the jacket can optionally have an opening (or mesh cover) aligned with the audio speaker 63 of the device 51 to limit the attenuation of the alarm tone produced by the audio speaker 63.

The tilt sensor 55 is adapted to sense its rotational orientation about a predefined axis and output one or more electrical signals that represent the sensed rotational orientation. The tilt sensor is mounted to the printed circuit board 53 such that when supported by the right jaw pad 37 the predefined axis 65 of the tilt sensor 55 is generally orthogonal to the direction of gravity and parallel to the transverse axis that passes through the center point of the opposed ear holes of the outer shell 10 as best shown in FIG. 2. In this configuration, the predefined axis 65 of the tilt sensor 55 is configured such that the tilt sensor 55 senses the rotational orientation (i.e., tilt angle) of the helmet 1 relative to a vertical axis extending along the straight spine of the user.

The processor 57 is operably coupled to the tilt sensor 55 and the audio speaker 63. The processor 57 is configured to perform cyclical operations that activate the tilt sensor 55 and sample and process the electrical signal(s) output by the tilt sensor 55. The processor 57 processes the electrical signal(s) output by the tilt sensor 55 to automatically detect that the helmet 1 has been tilted forward into an unsafe helmet position. In one embodiment, the unsafe helmet position corresponds to a tilt angle of the helmet relative to a vertical axis extending along the straight spine of the user that exceeds a threshold tilt angle in the range of sixty degrees to one hundred and fifty degrees. The processor 57 is further configured to automatically activate the audio speaker 63 such that it produces an audible alarm upon detecting that the helmet 1 has been tilted forward into an unsafe helmet position.

The tilt sensor 57, the processor 57, and the audio speaker 63 are powered by the battery 59. The battery 59 can be an electrochemical coin cell or other low voltage miniature battery (such as a 3C lithium ion coin cell). The battery 59 can be re-chargeable, if desired. Circuitry for recharging the battery 59 can be supported on the printed circuit board 53, if desired. A DC power source (such as a solar cell or AC/DC adapter) can be coupled to such recharging circuitry as is well known.

The switch 61 is actuated by the user to wake the processor 57 from an off-state (or deep low-power state) such that it automatically carries out its cyclical operations of activating the tilt sensor 55 and sampling and processing the electrical signal(s) output by the tilt sensor 55 for unsafe helmet position detection. The processor 57 can be configured to automatically transition to a low-power state under certain conditions of the electrical signal(s) output by the tilt sensor 55 that indicate the helmet is not in normal use. The switch 61 can also be configured to place the processor 57 into an off-state (or deep low-power state) in response to predetermined user activation of the switch 61, such as activating the switch 61 for a predetermined time period (such as three seconds or more). The off-state (or deep low-power state) of the processor 57 reduces the power consumption of the device 51 and thus the power drain on the battery of the device 51 for power conservation.

According to the present application, the cyclical operations of the processor 57 that carry out unsafe helmet position detection deactivate the tilt sensor 55 for certain time periods of the cycles in order to reduce the power consumption of the device 51 and thus the power drain on the battery 59. Such cyclical operations also preferably place the processor 57 in a low-power state for certain time periods of the cycles in order to reduce the power consumption of the device 51 and thus the power drain on the battery 59. These power saving features prolong the operational up-time of the electronic device 51.

The electrical signal(s) output of by the tilt sensor 55 typically includes unwanted high frequency noise due to the design of the sensor 55 and the high impact environment that the sensor 55 experiences during a football game or practice. The cyclical operations of the processor 57 that carry out unsafe helmet position detection are configured to filter out or remove the effect of such unwanted high frequency noise in the output signal(s) of the tilt sensor 55 in determining whether the helmet 1 is positioned in an unsafe position. Such filtering is also configured to constrain the time delay (t_{alarm-delay}) that the helmet is in an unsafe position before raising the alarm condition in order provide adequate warning of the unsafe helmet position to the user such that the user can correct his/her head position during use. Such filtering advantageously reduces false positive determinations of unsafe helmet position and resultant false alarm signals.

The processor 57 is a suitable combination of hardware, firmware and/or software. It can be realized by a programmed microcontroller or microprocessor system, an ASIC, a programmable gate array, a programmable logic device or other suitable programmable circuit. In one embodiment, the processor 57 is an LPC 111X family microcontroller sold commercially by NXP Semiconductors N.V. of Eindhoven, The Netherlands. The LPC 111X family of microcontrollers are ARM Cortex-MO based, low-cost 32-bit microcontrollers designed for 8/16-bit microcontroller applications. The LPC 111X family operate at CPU frequencies of up to 50 MHz. The peripheral complement of the LPC111X family includes up to 64 kB of flash memory, up to 8 kB of data memory, one fast-mode plus 12C-bus interface, one RS-485/EIA-485 UART, up to two SPI interfaces with SSP features, four general purpose counter/timers, a 10-bit ADC, and up to 42 general purpose I/O pins.

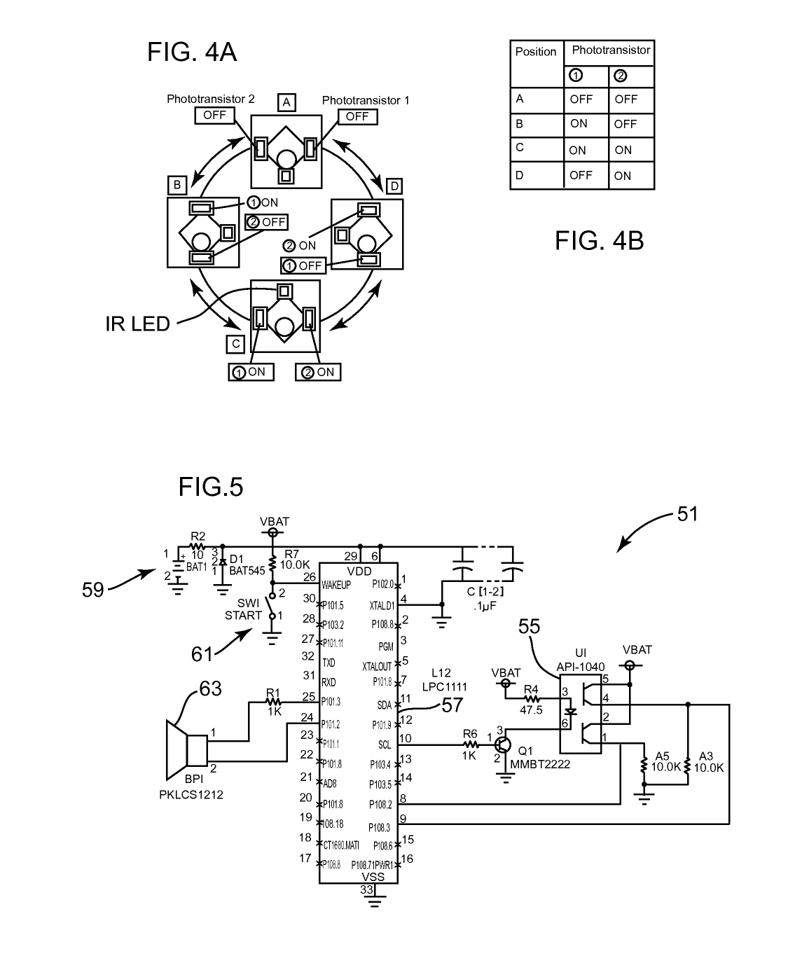

In one embodiment, the tilt sensor 55 is realized by the RPI-1040 photosensor sold commercially by Rohm Co., Ltd. of Kyoto, Japan, which includes an infra-red emitting diode (IR LED), two photodetectors and a small reflective ball enclosed in a small housing. The components are configured to sense four different rotational orientations as shown schematically in FIG. 4A. In a vertical orientation (where the rotational orientation of the tilt sensor 55 about the predefined axis 65 is generally aligned with the direction of gravity and labeled “A” in FIG. 4A) with the IR LED activated to emit IR radiation and the two photodetectors configured in a normally-off (non-conducting) state, the reflective ball rests close to the IR LED and blocks the transmission of IR radiation to the two photodetectors. In this vertical orientation, the two photodetectors remain in the off (non-conducting) state. If the tilt sensor 55 is rotated about the predefined axis 65 clockwise through ninety degrees with respect to the vertical orientation to a forward tilt orientation (labeled “B” in FIG. 4B), or if tilt sensor 55 is rotated about the predefined axis 65 counter-clockwise through ninety degrees with respect to the vertical orientation to a rearward tilt orientation (labeled “D” in FIG. 4A), with the IR LED activated to emit IR radiation and the two photodetectors configured in the normally-off (non-conducting) state, the reflective ball rests close to the one of the two photodetectors and blocks the transmission of IR radiation to this one photodetector. In the forward (or rearward) tilt orientation, the reflective ball directs the IR radiation emitted by the IR LED to the other photodetector which turns the other photodetector into its ON (conducting) state. If the tilt sensor 55 is rotated about the predefined axis 65 clockwise (or counter-clockwise) through one-hundred eighty degrees with respect to the vertical orientation to a downward tilt orientation (labeled “C” in FIG. 4A) with the IR LED activated to emit IR radiation and the two photodetectors configured in the normally-off (non-conducting) state, the reflective ball directs the IR radiation emitted by the IR LED to both photodetectors, which turns on both photodetectors into respective ON (conducting) states. The states of the two photodetectors for the four tilt orientations of the sensor 55 are summarized in tabular form in FIG. 4B.

The RPI-1040 photosensor can be integrally mounted to the right jaw pad 37 such that forward tilt orientation (labeled “B” in FIG. 4A) corresponds to a tilt angle of the helmet 1 relative to a vertical axis extending along the straight spine of the user in the range of sixty degrees to one hundred and fifty degrees. This tilt angle represents the threshold for unsafe helmet position. In this configuration, the predefined ON/OFF output states of the two photodetectors of the RPI-1040 photosensor in the forward tilt orientation (labeled “B” in FIG. 4A) provides an indication of unsafe helmet position.

FIG. 5 is a schematic of an illustrative embodiment of the electronic device 51 of the present application. The tilt sensor 55 is the RPI-1040 photosensor sold commercially by Rohm Co., Ltd. of Kyoto, Japan as described above. The processor 57 is the LPC 1111 microcontroller that belongs to the LPC 111X family of microcontrollers sold commercially by NXP Semiconductors N.V. of Eindhoven, The Netherlands as described above. The battery 59 provides DC power (VBAT) to the processor 57 via the VDD pin (pin 29). A capacitor network for a reference clock generator (e.g., oscillator) is coupled between the battery DC power (VBAT) and the XTALIN pin (Pin 4) of the processor 57. A normally-off power-on switch 61 is coupled to the battery DC power (VBAT) by a 10 KOhm pull-down resistor R7, whose pull-down node is connected to the WAKEUP pin (pin 26) of the processor 57. In this configuration, user actuation of the power-on switch 61 closes the normally-off switch 61 to trigger wakeup of the processor 57. The processor 57 is configured such that upon such wakeup, it performs the cyclical operations that activate the tilt sensor 55 and sample and process the electrical signal(s) output by the tilt sensor 55 for detection of unsafe helmet position. The output pin 10 of the processor 57 is coupled to the base of transistor Q1 via the 1 KOhm series-coupled resistor R6. The collector and emitter terminals of the transistor Q1 are part of a normally-off switchable current path that extends from the battery DC power (VBAT) through the 47.5 KOhm resistor R4, the IR LED of the RPI-1040 photosensor, and the collector and emitter of transistor Q1 to ground. In this configuration, the processor 57 can output a voltage signal on output pin 10 that turns on the transistor Q1. With the transistor Q1 in the on state, the switchable current path through the IR LED of the RPI-1040 photosensor is turned on and thus causes the IR LED to emit IR Radiation. The collector terminals (pins 2 and 5) of the two photodetectors of the RPI-1040 photosensor are connected to the battery DC power (VBAT). The emitter terminals (pins 1 and 4) of the two photodetectors are each coupled to ground via respective 10 KOhm resistors R3, R5 and to input pins 8, 9 respectively of the processor 57. In this configuration, in the event that the first photodetector of the RPI-1040 photosensor (pins 1 and 2) remains in its normally-off state, a digital low voltage signal is supplied to input pin 8 of the processor 57. Similarly, in the event that the second photodetector of the RPI-1040 photosensor (pins 4 and 5) remains in its normally-off state, a digital low voltage signal is supplied to input pin 9 of the processor 57. In the event that the first photodetector of the RPI-1040 photosensor turns on, a digital high voltage signal is induced across the resistor R5 and supplied to the input pin 8 of the processor 57. Similarly, in the event that the second photodetector of the RPI-1040 photosensor turns on, a digital high voltage signal is induced across the resistor R3 and supplied to the input pin 9 of the processor 57. The digital high/low voltage signals output from the sensor 55 and supplied to the input pins 8 and 9 of the processor 57 are indicative of the respective tilt orientations of the tilt sensor 55 as summarized in the table of FIG. 4B. The output pins 23 and 24 of the processor 57 are used to output a differential speaker drive signal to the speaker 63 that causes the speaker 63 to produce a suitable audible alarm tone.

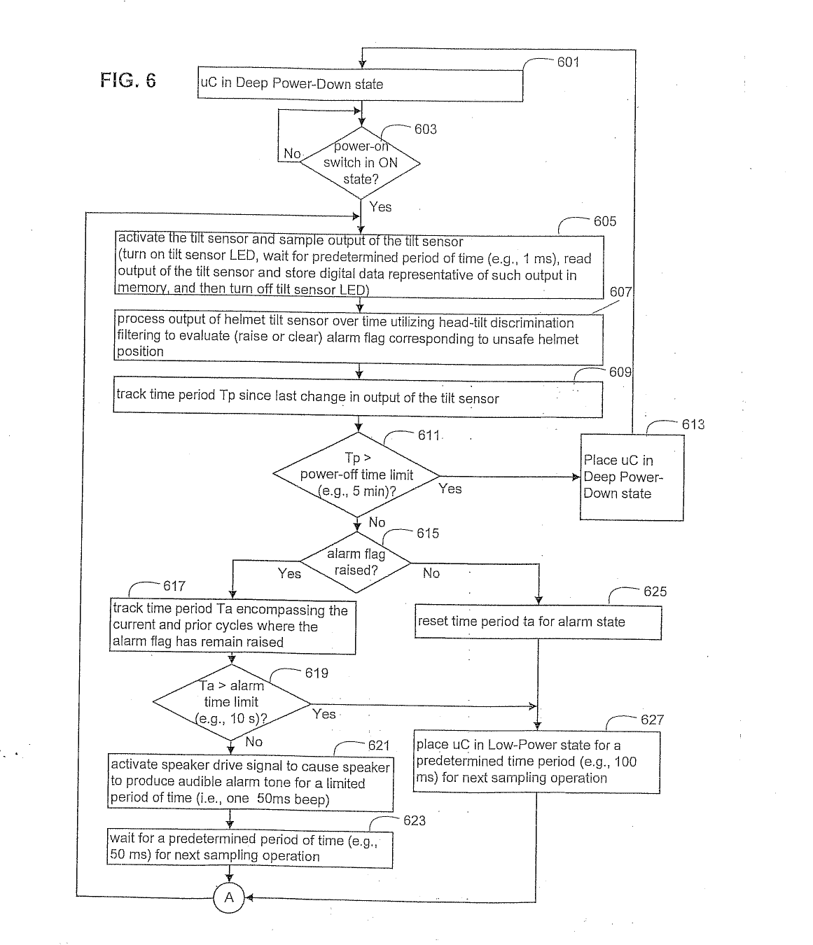

Referring to FIG. 6, there is shown a flow chart of exemplary cyclical operations of the processor 57 that activate the tilt sensor 55 and sample and process the electrical signal(s) output by the tilt sensor 55 for detection of unsafe helmet position. The operations begin in block 601 where the processor 57 is in a deep power-down state. In the deep power-down state, power and clocks can be shut off a large portion of the components of the processor 57 with the exception of the WAKEUP pin that is coupled to the power-on switch 61. During the deep power-down state, the contents of the SRAM and registers of the processor 57 are not retained except for a small amount of data which can be stored in the five 32-bit general purpose registers used for power management. Furthermore, the LED of the tilt sensor 55 is deactivated (with the transistor Q in its normally-off state) for reduced power consumption. In this manner, the deep power-down state of the processor 57 reduces the power consumption of the device 51 and thus the power drain on the battery of the device 51 for power conservation. Other low power states can be used.

In block 603, the processor 57 waits until the user actuates the power-on switch 61. The user actuation of the power-on switch 61 generates an electrical signal that is supplied to the WAKEUP pin of the processor 57. In response to this event, the processor 57 is configured to wake from the deep power-down state and automatically carry out the cyclical operations of blocks 605 to 627 that activate the tilt sensor 55 and sample and process the electrical signal(s) output by the tilt sensor 55 for unsafe helmet position detection. The duration for each cycle is dictated by the timing of certain operations of the cycle, including the duration of the audible tone in block 621, the wait duration in block 623, and the duration of the low-power state of block 627. In one embodiment, each cycle is on the order of 100 milliseconds as described below in more detail.

In block 605, the processor 57 activates the tilt sensor 55 and samples the output electrical signal(s) of the tilt sensor 55. This can involve turning on the IR LED of the RPI-1040 photosensor via output pin 10 of the processor 57, utilizing a timer of the processor 57 to wait for a predetermined time period (e.g., lms), reading the digital signals at input pins 8 and 9 of the processor 57 and storing such signals as digital data in the memory (e.g., register space or memory space) of the processor 57, and then turning off the IR LED of the RPI-1040 photosensor via output pin 10 of the processor 57. The digital data stored in block 605 is representative of the tilt orientation of the tilt sensor 55 for the current cycle.

In block 607, the processor 57 processes the digital data representative of the tilt orientation of the tilt sensor 55 as stored in block 605 for the current cycle as well as the digital data representative of the tilt orientation of the tilt sensor 55 stored in block 605 for zero or more previous cycles (such as for the last four previous cycles) in order to determine whether or not to raise an alarm flag corresponding to an unsafe helmet position. Such processing utilizes head-tilt discrimination filtering that filters out or remove the effect of such unwanted high frequency noise in the output signal(s) of the tilt sensor 55 in determining whether the helmet is positioned in an unsafe position. Such filtering advantageously reduces false positive determinations of unsafe helmet position and resultant false alarm signals.

In block 609, the processor 57 utilizes a timer to track (initialize or update as appropriate) the time period (Tp) since the last change in the digital data representative of the tilt orientation of the tilt sensor 55 as stored in block 605.

In block 611, the processor 57 evaluates the time period Tp to determine if it is greater than a predetermined power-off time limit. If so, the processor 57 continues to block 613 where the processor 57 is placed into the deep power-down state (or other low power state). The power-off time limit of block 611 is intended to automatically power down the device in the event that the helmet 1 is not in use. A power-off time limit of five minutes is suitable for this purpose. Other suitable time limits can be used as well.

If the time period Tp is not greater than the power-off time limit, the processor 57 continues to block 615 to determine whether the alarm flag was raised in block 607. If not, the operations continue to blocks 625 and 627. If so, the operations continue to block 617 where the processor utilizes a timer to track (initialize or update as appropriate) the time period Ta over successive cycles that the alarm flag remains raised.

In block 619, the processor 57 evaluates the time period Ta to determine if it is greater than a predetermined alarm time limit. If so, the operations continue to step 627. Otherwise, the operations continue to blocks 621 and 623.

In block 621, the processor 57 outputs a differential speaker drive signal to the speaker 63 that causes the speaker 63 to produce a suitable audible alarm tone for a limited duration. For example, the audible alarm tone can be a beep of 50 milliseconds in duration.

In block 623, the processor 57 utilizes a timer to wait for a predetermined period of time for the next sampling operation (cycle). In one embodiment, the predetermined period of time for the wait of block 523 is 50 milliseconds. Upon expiration of the wait time period of block 623, the operations return to block 605 for the next cycle.

In block 625, the processor 57 resets (or clears) the timer that tracks the time period Ta in block 617.

In block 627, the processor 57 places itself in a low-power state for a predetermined time period and continues to the next sampling operation (cycle) of block 605 at the expiration of this time period. In one embodiment, the low-power state (e.g., deep-sleep mode) disables the system clock to the processor 57 and all analog blocks are powered down except for certain components including a watchdog oscillator (which can be selected or deselected in a configuration register). The deep-sleep mode eliminates all power used by the flash and analog peripherals and all dynamic power used by the processor itself, memory systems and their related controllers, and internal buses. The processor state and registers, peripheral registers, and internal SRAM values are maintained, and the logic levels of the pins remain static. Furthermore, the LED of the tilt sensor 55 is deactivated (with the transistor Q in its normally-off state) for reduced power consumption. In this manner, the deep-sleep mode of the processor 57 reduces the power consumption of the device 51 and thus the power drain on the battery of the device 51 for power conservation. Other low power states can be used.

In the preferred embodiment, the predetermined time period of block 627 is 100 milliseconds.

Note that the processing of block 625 and 627 does not drive the speaker 63 such that speaker 63 does not produce an alarm tone as issued in the alarm condition of blocks 617 to 623. In this manner, alarm tones are not produced when the helmet is positioned in a safe position (i.e., not tilted forward beyond the threshold forward tilt angle).

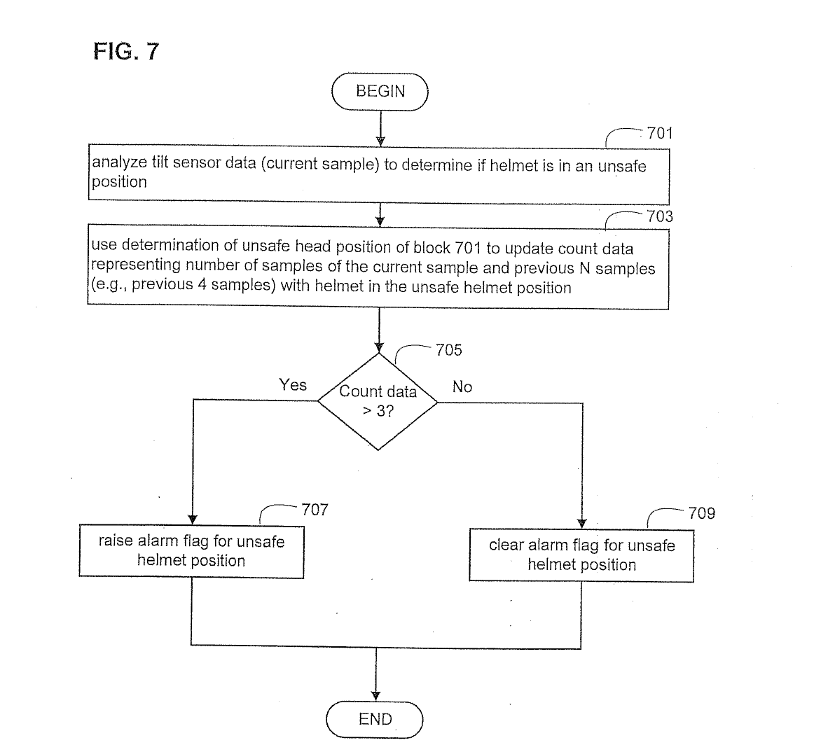

Referring to FIG. 7, there is shown a flow chart of exemplary operations that can be used as part of block 607 of FIG. 6 that processes the digital data representative of the tilt orientation of the tilt sensor 55 for multiple cycles in order to determine whether or not to raise an alarm flag corresponding to an unsafe helmet position. Such processing utilizes head-tilt discrimination filtering that filters out or removes the effect of such unwanted high frequency noise in the output signal(s) of the tilt sensor 55. The operations begin in block 701 where the processor 57 analyzes the digital data representative of the tilt orientation of the tilt sensor 55 for the current cycle (the current sample) to determine of the head is in an unsafe head position. For example, the processor 57 can analyze the digital data of the current sample to determine if the forward photodetector of the tilt sensor 55 has turned ON and has output a high level digital signal representative of an unsafe helmet position.

In block 703, the processor 57 utilizes the determination of unsafe helmet position of block 701 to update count data that the represents the number of samples of the current sample and the previous N samples (with N being an integer greater than 1) where the processing of block 701 has determined that the helmet is in an unsafe position. In the preferred embodiment, the integer N is 4 such that the count tracks five samples in total.

In block 705, the processor 57 evaluates the count data generated in block 703 to determine if it is greater than a predetermined threshold integer value, which is preferably set at 3. If so, the processor continues to block 707 to raise the alarm flag indicative of unsafe helmet position. Otherwise, the operations continue to step 709 where the processor 57 clears the alarm flag indicative of unsafe helmet position, which provides an indication that the helmet is in a safe position.

Note that the count data and threshold comparison of blocks 703 and 705 performs a head-tilt discrimination filtering function that filters out or removes the effect of unwanted high frequency noise in the output signal(s) of the tilt sensor 55. Such unwanted high frequency noise generally includes high frequency transient components that arise from rapid acceleration or deceleration of the head protector, which is typically experienced during an impact collision (e.g., tackle) or from running In these circumstances, the rapid acceleration or deceleration of the head protector can cause the reflective ball of the tilt sensor 55 to jump or move and introduce high frequency transient noise components into the output signals generated by the photodetectors of the tilt sensor 55. Such noise components are transient in nature with a duration typically less than 200 milliseconds. The head-tilt discrimination filtering function is also configured to constrain the time delay (t_{alarm-delay}) that the head protector is in an unsafe position before raising the alarm condition. Note that with a tilt sensor output sampling frequency on the order of 10 Hz (i.e., 1 sample per 100 milliseconds or 10 sample per second) as described herein, the count data evaluation of block 705 with the threshold set at 3 dictates that t_{alarm-delay} is no more than 0.5 seconds in magnitude. This parameter t_{alarm-delay} is selected to provide adequate warning of the unsafe helmet position to the user such that the user can correct his/her head position during use.

Note that other suitable head-tilt discrimination filtering can be used. For example, the processor 57 can operate on a large number of digital samples indicative of unsafe helmet position (e.g., twenty-five such samples captured at a high sampling rate) and filter such samples in the digital domain by digital filters that are tailored to reject the patterns of unwanted high frequency noise in the output signal(s) of the tilt sensor 55. In this manner, the digital filters of the processor 57 operate in the digital domain to filter out or remove the effect of such unwanted high frequency noise. The digital filters are also configured to constrain the time delay (t_{alarm-delay}) that the head protector is in an unsafe position before raising the alarm condition. The parameter t_{alarm-delay} is selected to provide adequate warning of the unsafe helmet position to the user such that the user can correct his/her head position during use. Such digital filters can be wavelet filters or other suitable digital filters. The processor 57 can operate on the output of the digital filters to determine if the helmet is in an unsafe head position and/or to determine whether or not to raise the alarm flag indicative of unsafe helmet position.

Note that many modifications or alterations can be made to the device as described above. For example, the components of the device 51 can be supported on both sides of the printed circuit board 53. This can reduce the size (area) of the printed circuit board 53. For example, the audio speaker 63 can be mounted one side of the printed circuit board 53 opposite the side that supports the tilt sensor 55, the processor 57 and the battery 59.

In other embodiments, the speaker 63 can be substituted by a piezoelectric beeper or other sound producing device. A visual alarm, such as an LED light, can be added and triggered in the unsafe helmet position. Tracking and reporting capabilities for the alarm conditions over time can be added. For example, such information can be generated and stored by the processor 57 and communicated to a host system by a wired or wireless communication link as is well known in the electronic arts. Such information can also be displayed on a display device (such as LCD character display) that is integral to the device 51 or connected thereto.

In the embodiment described above, the electronic device is integrated into the jaw pad of the football helmet. In other embodiments, the location where the device 51 is integrated into the structure of the football helmet can be modified. For example, the electronic device can be housed in a compartment molded into the side of the helmet, or possibly in an external rubberized module that is inserted into the ear hole or other part of the football helmet. It can also be supported in a recess formed in the chin pad 17. It can also be supported by other parts of the football helmet, such as the crown section (or the crown pad) or the rear section (or the rear portion of the shock-absorbing liner, such as behind the ear hole). For ease of use, it may be preferable that the electronic device 51 be accessible by the user such that it can be turned on (and possibly off) as desired and to allow for changing or recharging the battery of the device as desired.

In yet other embodiments, the electronic device as described above can be integrated into head protectors for other impact sports, such as men's lacrosse helmets, ice hockey helmets, and rugby head protectors.

The electronic device of the present invention can be used as a training aid for young and/or inexperienced participants in an impact sport in order to train such participants to avoid placing their head in unsafe positions (i.e., in a head down position) while playing the impact sport.

There have been described and illustrated herein several embodiments of an electronic device for impact sport head protectors. While particular embodiments of the invention have been described, it is not intended that the invention be limited thereto, as it is intended that the invention be as broad in scope as the art will allow and that the specification be read likewise. Thus, while particular head-tilt discrimination filtering schemes and operations have been disclosed, it will be appreciated that other head-tilt discrimination filtering schemes can be used as well. In addition, while particular types of tilt sensors and microprocessors have been disclosed, it will be understood that other tilt sensors and microprocessors can be used. For example, and not by way of limitation, accelerometers, rolling-ball switches, and mercury switches can be used for tilt sensing. It will therefore be appreciated by those skilled in the art that yet other modifications could be made to the provided invention without deviating from its spirit and scope as claimed.

What is claimed is:

1. An electronic device for use in an impact sport head protector, the electronic device comprising:
a tilt sensor that generates at least one output signal representing tilt orientation of the head protector;
a processor, operably coupled to the tilt sensor, that is configured to sample and process the at least one output signal of the tilt sensor over a number of successive cycles, wherein the processing for a given cycle determines whether the head protector is positioned in an unsafe position during the given cycle and generates an alarm signal based on such determination at least for the given cycle; and
an audio device, operably coupled to the processor, that is configured to produce an audible alarm in response to the alarm signal generated by the processor;
wherein the processing of the processor is configured to remove the effect of unwanted noise components in the at least one output signal of the tilt sensor in generating the alarm signal.

2. An electronic device according to claim 1, wherein:
the processing of the processor constrains the time delay t_{alarm-delay} that the head protector is in an unsafe position before raising the alarm signal in order provide warning of the unsafe helmet position to the user such that the user can correct his/her head position during use.

3. An electronic device according to claim 2, wherein:
the time delay t_{alarm-delay} is not more than 0.5 seconds.

4. An electronic device according to claim 1, wherein:
the processor is configured to maintain count data pertaining to the determination whether the head protector is positioned in an unsafe position during a number of cycles; and
the processor generates an alarm signal based upon evaluation of the count data and predefined threshold criterion.

5. An electronic device according to claim 1, wherein:
the processor selectively controls the audio device to produce the audible alarm in response to the alarm signal generated by the processor.

6. An electronic device according to claim 1, wherein:
the processor selectively controls the audio device to produce the audible alarm for a predetermined duration in response to the alarm signal generated by the processor.

7. An electronic device according to claim 6, wherein:
the processor tracks a time period Ta over successive cycles that the alarm signal is generated; and
the processor selectively controls the audio device to produce the audible alarm for the predetermined duration based upon the time period Ta.

8. An electronic device according to claim 7, wherein:
the processor controls the audio device to produce the audible alarm for the predetermined duration in the event that the time period Ta is less than a predetermined threshold criterion.

9. An electronic device according to claim 1, wherein:
in the event that the processing for a given cycle determines that the head protector is not positioned in an unsafe position in the given cycle, the processor places itself into a low-power state for a predetermined period of time before the next cycle.

10. An electronic device according to claim 1, wherein:
the process tracks a time period Tp since the last change in the at least one output signal of the tilt sensor; and
the processor selectively controls itself to enter a low-power state based upon the time period Tp.

11. An electronic device according to claim 10, further comprising:
a user-activated switch, wherein the processor is configured to wake from the low-power state in response to user-activation of the switch.

12. An electronic device according to claim 1, further comprising:
a user-activated switch, wherein the processor is initially configured in a lower state, and is further configured to wake from the low-power state in response to user-activation of the switch.

13. An electronic device according to claim 1, wherein:
the processing of the processor in a given cycle includes digital filtering that rejects unwanted noise components in the at least one output signal of the tilt sensor.

14. An electronic device according to claim 13, wherein:
the output of the digital filtering is used to determine whether the head protector is positioned in an unsafe position during a given cycle.

15. An electronic device according to claim 13, wherein:
the output of the digital filtering is used to generate the alarm signal.

16. An electronic device according to claim 1, further comprising:
a housing that encloses the device, wherein the housing in configured to be supported by a part of the head protector.

17. An electronic device according to claim 16, wherein:
the housing is configured to fit into an opening of the head protector that is adjacent an ear of the user.

18. A head protector for an impact sport, the head protector comprising:
an electronic device according to claim 1.

19. A head protector according to claim 18, further comprising:
a shock-absorbing structure, wherein the electronic device is integral to a portion of the shock-absorbing structure.

20. A head protector according to claim 18, wherein:
the portion of the shock-absorbing structure is a jaw pad.

21. A head protector according to claim 18, further comprising:
a protective outer shell, wherein the electronic device is supported within a compartment integral to the protective outer shell.

22. A chin strap for a head protector, the chin strap comprising:
an electronic device according to claim 1, wherein the electronic device is supported within a compartment integral to the chin strap.
